(19) United States
(12) Patent Application Publication
(10) Pub. No.: US 2011/0050544 A1
(43) Pub. Date: Mar. 3, 2011

(54) IMAGE DISPLAY SYSTEM INCLUDING A PLURALITY OF ELECTRONIC PAPER DISPLAY DEVICES

(75) Inventor: Keitaro TOMONO, Nagoya-shi (JP)

(73) Assignee: BROTHER KOGYO KABUSHIKI KAISHA, Aichi-ken (JP)

(21) Appl. No.: 12/788,895

(22) Filed: May 27, 2010

(30) Foreign Application Priority Data
Aug. 25, 2009 (JP) 2009-193953

(51) Int. Cl. G09G 5/00

(52) U.S. Cl. 345/1.3

(57) ABSTRACT

An image display system includes a plurality of electronic paper display devices, each displaying an image thereon, a first determining unit that determines positions of the plurality of electronic paper display devices relative to each other, and a control unit that controls each of the electronic paper display devices in accordance with the positions determined by the determining unit such that the plurality of electronic paper display devices together display a single image.

### CROSS REFERENCE TO RELATED APPLICATION

This application claims priority from Japanese Patent Application No. 2009-193953 filed Aug. 25, 2009. The entire content of this priority application is incorporated herein by reference.

### TECHNICAL FIELD

The present invention relates to an image display system and an image processing device for displaying images on a plurality of electronic paper display devices, and also relates to an electronic paper display device for displaying electronic images thereon.

### BACKGROUND

An electronic paper display device has recently been put to practical use as a portable electronic document viewer. There has also been provided a system that communicably connects between an electronic paper display device and a printing device to establish data communication therebetween. For example, Japanese Patent Application Publication No. 2008-225551 discloses a system in which an image processing device outputs print data, which is to be printed by a printing device, to the printing device, and the printing device converts the print data into display data, which an electronic paper display device can display, and outputs the display data to the electronic paper display device.

### SUMMARY

There is a case where a plurality of electronic paper display devices are juxtaposed side by side to together display a single image, such as a plural-page spread or a single-page worth of image in a magnified size. In other words, the single image consists of a plurality of images each displayed on one of the plurality of electronic paper display devices arranged in a corrected order. In this case, however, a user needs to arrange the plurality of electronic paper display devices in the correct order, and this is inconvenient for the user.

In view of the foregoing, it is an object of the invention to provide an image display system, an image processing device, and an electronic paper display device, capable of displaying a single image on a plurality of electronic paper display devices in a simple manner.

In order to attain the above and other objects, the invention provides an image display system including a plurality of electronic paper display devices, a first determining unit, and a control unit. Each of the electronic paper display devices displays an image thereon. The first determining unit determines positions of the plurality of electronic paper display devices relative to each other. The control unit controls each of the electronic paper display devices in accordance with the positions determined by the determining unit such that the plurality of electronic paper display devices together display a single image.

According to another aspect, the present invention provides an image processing device communicable with a plurality of electronic paper display devices. The image processing device includes a determining unit, a selecting unit, and a sending unit. The determining unit determines positions of the plurality of electronic paper display devices relative to each other. The selecting unit selects one of the plurality of electronic paper display devices for each of plural sets of image data. The sending unit sends each of the plural sets of image data to one of the plurality of electronic paper display devices selected by the selecting unit, so as to enable the plurality of electronic paper display devices to together display a single image. The single image consists of a plurality of partial image corresponding to the plural sets of image data.

According to still another aspect, the present invention provides an electronic paper display device including a display unit, a determining unit, and a control unit. The display unit displays an image based on data. The determining unit determines a position of the electronic paper display device relative to another electronic paper display device located adjacent to the electronic paper display device. The control unit controls the display unit to display the image based on the position of the electronic paper display device. The image is a part of a single image, and the single image consisting of the image and another image displayed by the another electronic paper display device.

### BRIEF DESCRIPTION OF THE DRAWINGS

The particular features and advantages of the invention as well as other objects will become apparent from the following description taken in connection with the accompanying drawings, in which:

FIG. 1 is a block diagram showing electrical configuration of an image display system according to a first embodiment of the invention;

FIG. 2 is a block diagram showing electronic configuration of an MFP and an electronic paper display device included in the image display system of FIG. 1;

FIG. 3 is a perspective view of the electronic paper display device;

FIG. 4 is a plan view of the electronic paper display device displaying an image thereon;

FIG. 5 is a plan view of a plurality of electronic paper display devices connected to each other and together displaying a two-page spread;

FIG. 6 a plan view of a plurality of electronic paper display devices connected to each other and together displaying a one-page worth of image in a magnified size;

FIG. 7 is a flowchart representing a reading/sending process executed in the MFP according to the first embodiment of the invention;

FIG. 8 is a flowchart representing a display process executed in the electronic paper display device according to the first embodiment of the invention;

FIG. 9 is a flowchart representing a page turn process executed in the electronic paper display device according to the first embodiment of the invention;

FIG. 10 is a flowchart representing a first reading/sending process executed in an MFP according to a second embodiment of the invention; and

FIG. 11 is a flowchart representing a second reading/sending process executed in the MFP according to the second embodiment of the invention.

### DETAILED DESCRIPTION

Image display systems according to embodiments of the invention will be described while referring to the accompanying drawings wherein like parts and components are designated by the same reference numerals to avoid duplicating description.

### First Embodiment

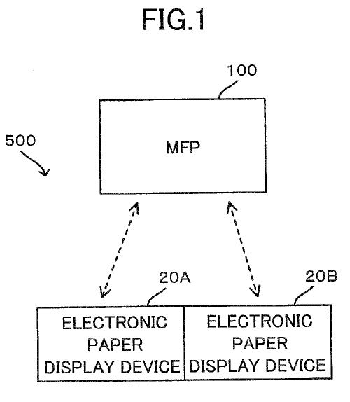

As shown in FIG. 1, an image display system 500 according to a first embodiment of the invention includes a multi function peripheral (MFP) 100 serving as an image processing device, and electronic paper display devices 20A and 20B serving as electronic document viewers. The MFP 100 has an image reading function and a printing function. Each electronic paper display device 20A, 20B is capable of displaying image data stored in an internal memory thereof. Note that the image display system 500 may alternatively include three or more electronic paper display devices.

Each of the MFP 100 and the electronic paper display devices 20A and 20B has such wireless communication function as Bluetooth (registered trademark) Thus, when the electronic paper display devices 20A and 20B are located within a communicable range of the MFP 100, the MFP 100 can read data from and write data to the electronic paper display devices 20A and 20B.

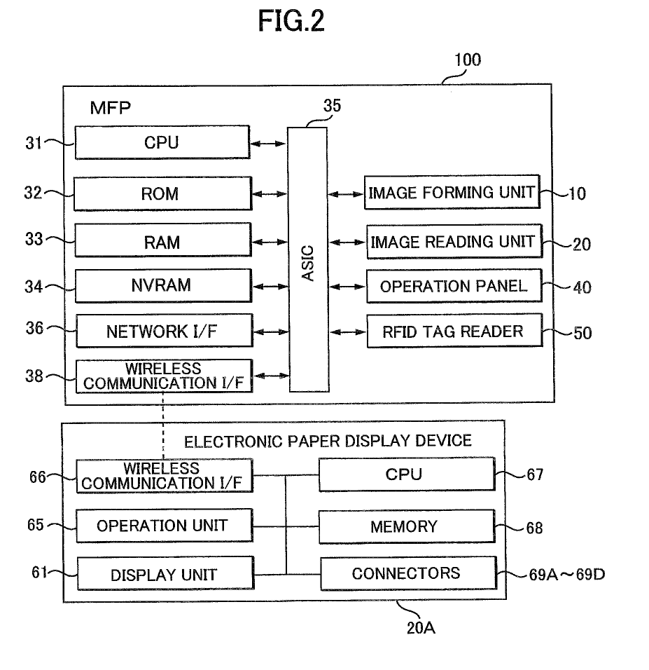

As shown in FIG. 2, the MFP 100 includes a CPU 31, a ROM 32, a RAM 33, a non-volatile RAM (NVRAM) 34, a network interface (I/F) 36, a wireless communication I/F 38, an image forming unit 10, an image reading unit 20, an operation panel 40, and a radio frequency identification (RFID) tag reader 50, all electrically connected via an ASIC 35.

The image forming unit 10 is for forming an image on a paper sheet in one of conventional image forming methods, such as an electrophotographic method or an inkjet method. The image forming unit 10 may be either capable of printing color images or capable of printing monochromatic images only.

The image reading unit 20 is for reading an image on an original. The image reading unit 20 has an auto document feeder (ADF) for automatically feeding sheets of original, and is capable of sequentially read images from a plurality of sheets of original.

Although not shown in the drawings, the operation panel 40 includes a display unit having a liquid crystal display panel, for example, and various buttons including a start key, a stop key, and numeral keys. The operation panel 40 displays operation status of the MFP 100 or the like, and accepts user's input.

The RFID tag reader 50 detects a RFID tag, and writes data to and reads data from the RFID tag. The RFID tag reader 50 is disposed on the MFP 100 within a range where the RFID tag reader 50 can access a RFID tag attached to an original placed on an original tray (not shown) of the MFP 100.

The ROM 32 stores various control programs for controlling the MFP 100, various settings, and various initial values. The RAM 33 provides a work area to which the various control programs are read and also a memory area where image data is temporarily stored.

The CPU 31 controls the above-mentioned various components of the MFP 100 via the ASIC 35 based on signals from either the control programs read from the ROM 32 or various sensors while storing processed results into either the RAM 33 or the NVRAM 34.

The network I/F 36 is communicable with an external information processing device with a printer driver for the MFP 100 installed thereon through such network as Internet to which the network I/F 36 is connected. The wireless communication I/F 38 is communicable with devices (the electronic paper display devices 20A and 20B in this embodiment) having a wireless communication function. Thus, the MFP 100 exchanges data between these devices through either the network I/F 36 or the wireless communication I/F 38.

Next, general configuration of the electronic paper display device 20A will be described. Note that because configuration of the electronic paper display device 20B is the same as that of the electronic paper display device 20A, description thereof will be omitted.

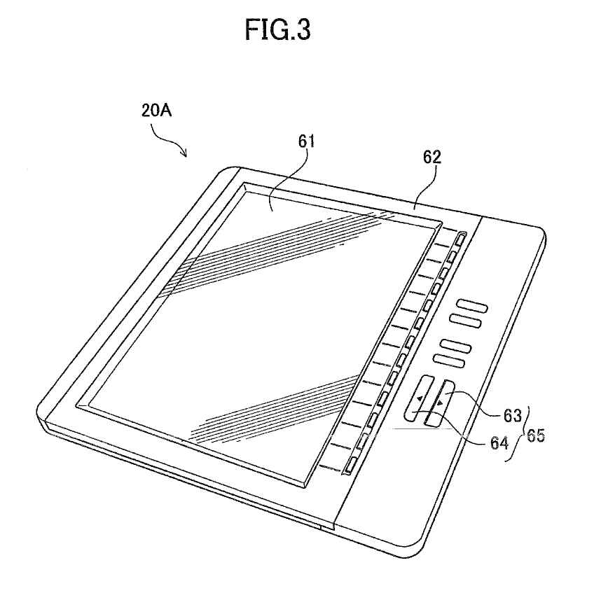

As shown in FIGS. 2 and 3, the electronic paper display device 20A includes a display unit 61, a frame 62, an operation unit 65, a wireless communication I/F 66, a CPU 67, a memory 68, and connectors 69A, 69B, 69C, and 69D.

The display unit 61 is a liquid crystal display panel that displays image data stored in the memory 68. The operation unit 65 includes various buttons including a power button, a page forward button 63, a page backward button 64, and the like, and accepts user's input commanding, for example, to switch screens on the display unit 61.

The memory 68 provides a work area to which various control programs are read and also a memory area for storing image data. The CPU 67 executes various processes based on control programs read from the memory 68 and signals from various sensors to control the above-mentioned various components of the electronic paper display device 20A while storing the processed results into the memory 68.

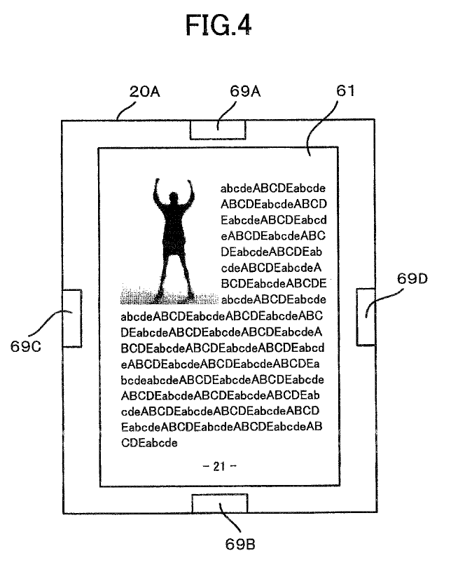

The connectors 69A, 69B, 69C, and 69D are for connecting with other electronic paper display device. More specifically, as shown in FIG. 4, one of the connectors 69A, 69B, 69C, and 69D is disposed on each peripheral edge of the electronic paper display device 20A, which is in a rectangular shape. In this embodiment, assuming that the electronic paper display device 20A is placed in an orientation shown in FIG. 4 such that a longitudinal direction of the electronic paper display device 20A extends along an up-to-down direction, the connectors 69A, 69B, 69C, and 69D are disposed on the upper, lower, left, and right edges of the electronic paper display device 20A, respectively.

The connector 69A is connectable to a connector 69B of other electronic paper display device, and the connector 69B is connectable to a connector 69A of other electronic paper display device. The connector 69C is connectable to a connector 69D of other electronic paper display device, and the connector 69D is connectable to a connector 69C of other electronic paper display device.

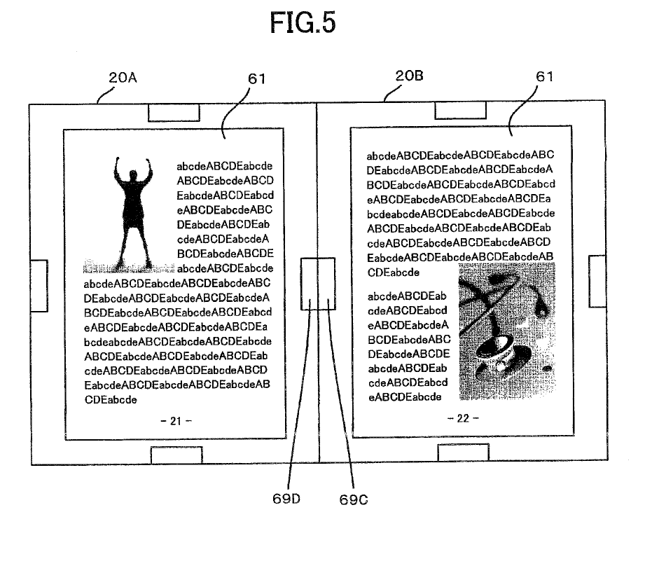

Each of the connectors 69A, 69B, 69C, and 69D is embedded with a sensor for detecting whether other electronic paper display device is connected thereto. Thus, as shown in FIG. 5, when the connector 69D of the electronic paper display device 20A is connected to the connector 69C of the electronic paper display device 20B, for example, then the electronic paper display device 20A detects that other electronic paper display device is connected to the right side, and the electronic paper display device 20B detects that other electronic paper display device is connected to the left side.

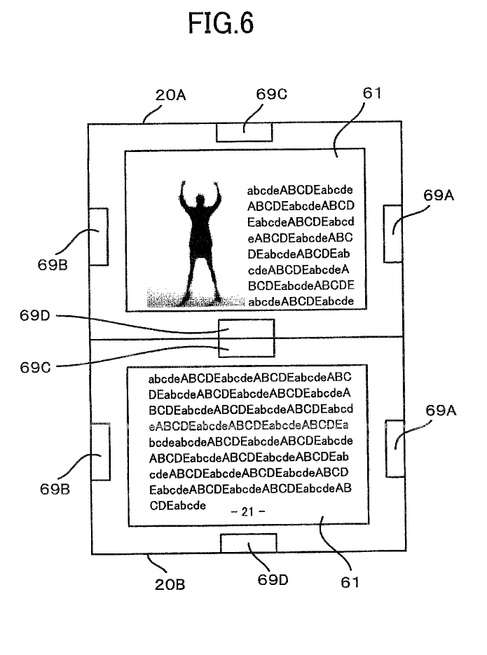

Next, operations of the electronic paper display device 20A will be described. The electronic paper display device 20A of the embodiment has three display modes including a basic display mode, a spread display mode, and an enlargement display mode. In the basic display mode, the electronic paper display device 20A displays one-page worth of image data by itself, as shown in FIG. 4. In the spread display mode, the electronic paper display device 20A is connected to other electronic paper display device(s), and the electronic paper display device 20A and the other electronic paper display device(s) together display a plural-page spread (plural-page worth of image data). For example, in FIG. 5, the electronic paper display devices 20A and 20B connected to each other together display a two-page spread. In this case, each electronic paper display device 20A, 20B displays one-page worth of image data. In the enlargement display mode, the electronic paper display device 20A is connected to other electronic paper display device(s), and the electronic paper display device 20A and the other electronic paper display device(s) together display one-page worth of image data in an enlarged size. For example, in FIG. 6, the electronic paper display devices 20A and 20B connected to each other together display a one-page worth of image in an enlarged size. In this case, each electronic paper display device 20A, 20B displays only part of the one-page worth of image data.

In the present embodiment, the MFP 100 has a function to write data to each electronic paper display device. That is, the MFP 100 sends image data to be displayed on the electronic paper display device 20A, 20B to the electronic paper display device 20A, 20B. The image data may be data that the MFP 100 generates by scanning an original or data that the MFP 100 reads out from an external device (PC or USB memory, for example) connected to the MFP 100, for example. The electronic paper display device 20A, 20B selectively displays image data when requested.

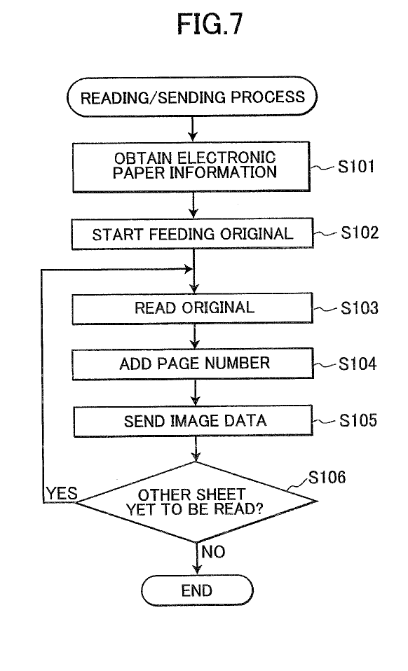

Next, a reading/sending process executed in the MFP 100 will be described with reference to the flowchart of FIG. 7. The reading/sending process is for reading an original to generate image data and to send the image data to the electronic paper display device 20A, 20B, and is executed when a scanning command for scanning an original with the ADF is input while writing to electronic paper display device is specified.

In this process, first in S101 the CPU 31 of the MFP 100 obtains information of each electronic paper display device located within the communicable range of the MFP 100 through a wireless communication. In this example, it is assumed that the electronic paper display devices 20A and 20B are in the communicable range, and the CPU 31 obtains information for the electronic paper display devices 20A and 20B in S101. More specifically, the CPU 31 outputs a request signal to each electronic paper display device 20A, 20B. In response to the request signal, each electronic paper display device 20A, 20B outputs to the MFP 100 a response signal containing predetermined information (unique identification number allocated to the electronic paper display device 20A, 20B, user information, a position of the electronic paper display device 20A, 20B relative to other electronic paper display device if the electronic paper display device 20A, 20B is connected to the other electronic paper display device, for example). Note that if the CPU 31 receives no response signal, then the CPU 31 controls the operation panel 40 to display an error message indicating no electronic paper display device is available and waits until any response signal is received.

Next in S102 the CPU 31 controls the image reading unit 20 to start auto-feed of one or more sheets of original with the ADF. The sheets of original are fed one at a time starting from a top page. Then in S103, the CPU 31 controls the image reading unit 20 to read an original image (one-page worth of image) from a single sheet of original to generate image data, and in S104 adds a page number to the image data, i.e., generates image data corresponding to the original image with the page number added thereto.

Next in S105, the CPU 31 sends the image data generated in S104 to each electronic paper display device 20A, 20B from which the CPU 31 has received the response signal in S101. That is, if the CPU 31 has received the response signals from a plurality of electronic paper display devices in S101, then the CPU 31 outputs the image data to all of the plurality of electronic paper display devices in S105.

In S106, the CPU 31 determines whether or not there is any sheet of original yet to be read. If so (S106:Yes), then the CPU 31 returns to S103 to repeat the process for a next sheet of original. On the other hand, if not (S106:No), then the CPU 31 ends the reading/sending process.

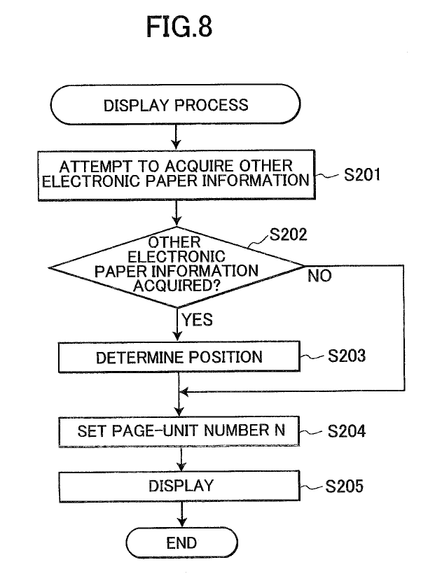

Next, a display process (corresponding to a first determining unit and a control unit) executed in each electronic paper display device 20A, 20B will be described with reference to the flowchart of FIG. 8. The display process is for displaying image data and is executed when the electronic paper display device 20A, 20B accepts a display command.

The display process will be described assuming that the display process is executed in the electronic paper display device 20A.

In this process, first in S201, the CPU 67 of the electronic paper display device 20A attempts to obtain information of other electronic paper display device. More specifically, the CPU 67 determines whether or not each of the connectors 69A, 69B, 69C, and 69D is connected to other electronic paper display device, based on detection signals from the sensors embedded in the respective connectors 69A, 69B, 69C, and 69D, and obtains information of other electronic paper display device if any of the connectors 69A, 69B, 69C, and 69D is connected to the other electronic paper display device. Also, if any of the connectors 69A, 69B, 69C, and 69D is connected to the other electronic paper display device, then the CPU 67 inquires whether another electronic paper display device is connected to the other electronic paper display device.

Then, in S202 the CPU 67 determines whether or not information of other electronic paper display device is obtained in S201. If so (S202:Yes), then in S203 the CPU 67 determines a position of the electronic paper display device 20A relative to the other electronic paper display device. For example, if the electronic paper display devices 20A and 20B are connected to each other as shown in FIG. 5, then the CPU 67 recognizes that two electronic paper display devices are connected to each other and that the electronic paper display device 20A is on the left side, i.e., that the position of the electronic paper display device 20A is the left.

On the other hand, if a negative determination is made in S202 (S202:No), then the CPU 67 skips S203 and directly proceeds to S204.

In S204, the CPU 67 sets a page-unit number N. If the electronic paper display device 20A is not connected to any other electronic paper display device, then the CPU 67 sets the page-unit number N to “1”. In this case, the electronic paper display device 20A is set to the normal display mode. However, if the electronic paper display device 20A is connected to one or more other electronic paper display devices, then the CPU 67 sets the page-unit number N in accordance with the number of electronic paper display devices connected to each other and the position of the electronic paper display device 20A. For example, if two electronic paper display devices are connected to each other as shown in FIG. 5, then it is determined that these electronic paper display devices are for displaying a two-page spread, and the page-unit number N is set to “2”. If another electronic paper display device (not shown) is connected to one of the electronic paper display devices shown in FIG. 5, then it is determined that these three electronic paper display devices are for displaying a three-page spread, then the page-unit number N is set to “3”. In these cases, the electronic paper display device 20A is set to the spread display mode. If two electronic paper display devices are connected to each other as shown in FIG. 6, then it is determined that these two electronic paper display devices are for the enlargement display, and the page-unit number N is set to “1”. In this case, the electronic paper display device 20A is set to the enlargement display mode.

Next in S205, the CPU 67 displays an image on the display unit 61. More specifically, if the electronic paper display device 20A is in the normal display mode, then the CPU 67 reads image data for a current page from the memory 68 and controls the display unit 61 to display the image data. If the electronic paper display device 20A is in the spread display mode, then the CPU 67 reads image data of a page number corresponding to the position of the electronic paper display device 20A from the memory 68 and controls the display unit 61 to display the image data. If the electronic paper display device 20A is in the enlargement display mode, then the CPU 67 extracts part of image data of a current page corresponding to the position of the electronic paper display device 20A and controls the display unit 61 to display the extracted part of the image data. Then, the CPU 67 ends the display process.

According to the display process of the embodiment, when a plurality of electronic paper display devices are connected to each other, a single image is displayed on the plurality of electronic paper display devices in accordance with connection state of the electronic paper display devices. Note that in this embodiment the single image means an image consisting of a plurality of images arranged in a correct order.

In this embodiment, the display command that triggers the execution of the display process is generated when main power of the electronic paper display device 20A is turned ON or when image data to be displayed is selected. The display command is also generated when connection between electronic paper display devices is interrupted or when any electronic paper display device is newly connected. That is, the displayed content is changed in association with change in the connection state of electronic paper display devices. Note that the electronic paper display device stores the page number that the electronic paper display device currently displays, and changes contents to display based on the stored page number when the connection state is changed.

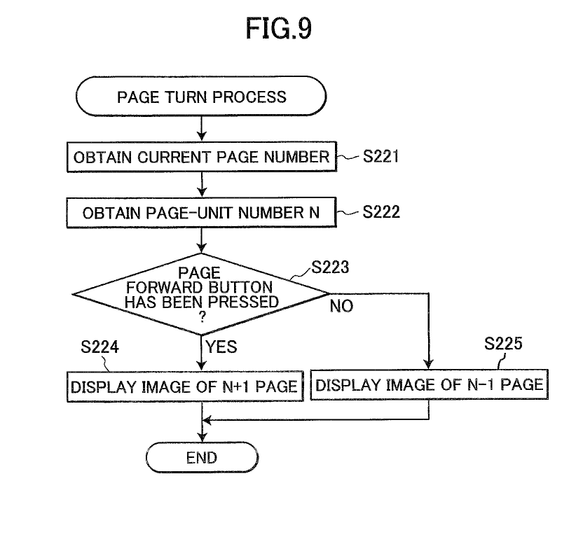

Next, a page turn process (corresponding to a control unit) executed in the electronic paper display device 20A, 20B will be described with reference to the flowchart of FIG. 9. The page turn process is executed when either the page forward button 63 or the page backward button 64 (FIG. 3) is pressed. The page turn process will be described next, assuming that the page turn process is executed in the electronic paper display device 20A.

In this process, first in S221 the CPU 67 obtains the page number that the electronic paper display device 20A is currently displaying, and in S222 obtains the page-unit number N. Note that the process of S222 may be performed before the process of S221.

Next in S223 the CPU 67 determines whether or not the button that has been pressed is the page forward button 63. If so (S223:Yes), then in S224 the CPU 67 increments the current page number by the page-unit number N, and controls the display unit 61 to display image data of the incremented page number. Then, the CPU 67 ends the page turn process.

On the other hand, if the button that has been pressed is the page backward button 64 (S223:No), then in S225 the CPU 67 decrements the current page number by the page-unit number N, and controls the display unit 61 to display image data of the decremented page number. Then, the CPU 67 ends the page turn process.

In this manner, according to the page turn process of the invention, the page is turned in accordance with the connection state even when a plurality of electronic paper display devices are connected to each other.

Note that the page turn process is also executed in the electronic paper display device 20A when either the page forward button 63 or the page backward button 64 of other electronic paper display device connected to the electronic paper display device 20A is pressed. That is, the electronic paper display device 20A turns the page when page is turned in other electronic paper display device connected thereto. For example, if either the page forward button 63 or the page backward button 64 of the electronic paper display device 20A is pressed while the electronic paper display device 20A is connected to the electronic paper display device 20B as shown in FIG. 5, then the electronic paper display device 20A outputs to the electronic paper display device 20B a signal indicating that either the page forward button 63 or the page backward button 64 is pressed. Then, the electronic paper display device 20B executes the page turn process upon receiving the signal. Thus, it is possible to remove a burden on a user in having a plurality of electronic paper display devices connected to each other display a right combination of images when turning the page.

### Second Embodiment

Next, a second embodiment of the invention will be described. In the above-described first embodiment, the MFP 100 sends the same image data to each electronic paper display device 20A, 20B, and the electronic paper display device 20A, 20B displays part of the image data corresponding to the position thereof. However, in this embodiment, the MFP 100 detects the connection state of the electronic paper display devices 20A and 20B and sends different image data to each electronic paper display device 20A, 20B.

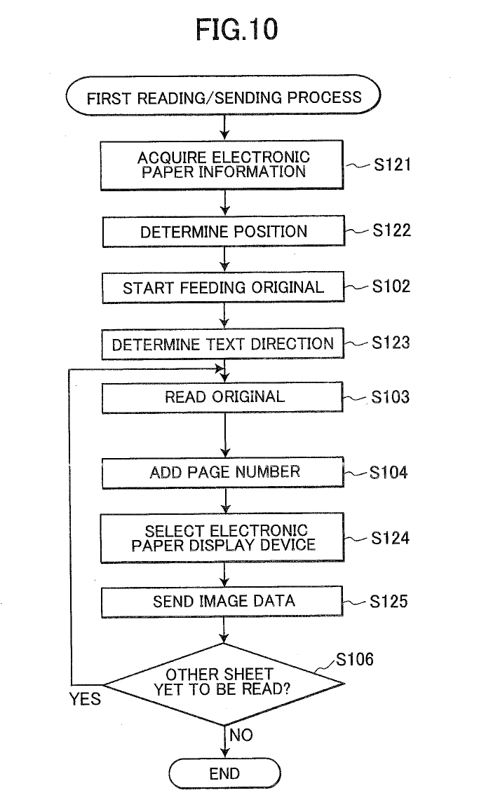

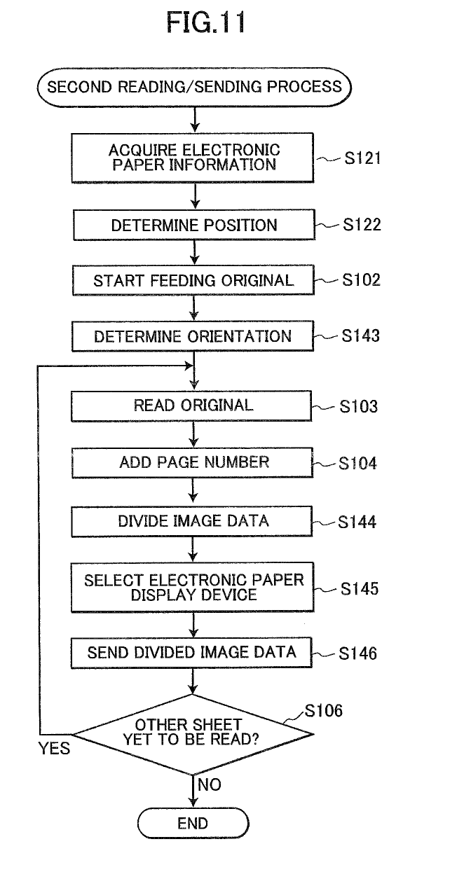

More specifically, in this embodiment, a first reading/sending process (corresponding to a first determining unit, a control unit, and a second determining unit) shown in FIG. 10 and a second reading/sending process (corresponding to a first determining unit and a control unit) shown in FIG. 11 are executed in the MFP 100 instead of the reading/sending process shown in FIG. 7. The first and second reading/sending processes are executed when the scanning command is input while writing to electronic paper display device is specified, but the first reading/sending process is executed if the spread display mode is selected, and the second reading/sending process is executed if the enlargement display mode is selected. That is, in this embodiment, a user specifies one of the spread display mode and the enlargement display mode before the user inputs the scanning command.

First, the first reading/sending process will be described with reference to the flowchart of FIG. 10. Note that processes that are the same as those of FIG. 7 will be assigned with the same step numbers. Also, in this embodiment, a RFID sheet attached with a RFID tag is used as a first sheet of original, and the RFID tag stores at least information identifying a text direction, i.e., whether an original text is written vertically or horizontally and/or an orientation (portrait or landscape) of original.

In this process, first in S121, the CPU 31 wirelessly communicates with any electronic paper display device (electronic paper display devices 20A and 20B, in this embodiment) in the communication range of the MFP 100 and obtains information from each electronic paper display device 20A, 20B. That is, the CPU 31 outputs the request signal to each electronic paper display device 20A, 20B, and the electronic paper display device outputs a response signal to the MFP 100. The response signal includes at least position information indicating a position of the electronic paper display device 20A, 20B.

For example, when the electronic paper display devices 20A and 20B are connected to each other as shown in FIG. 5, then the electronic paper display device 20A outputs a response signal indicating that other electronic paper display device (the electronic paper display device 20B) is connected to the right, and the electronic paper display device 20B outputs a response signal indicating that other electronic paper display device (the electronic paper display device 20A) is connected to the left.

Then, in S122, the CPU 31 determines the position of each electronic paper display device 20A, 20B based on the information included in the response signal. Next, in S102, the CPU 31 controls the image reading unit 20 to start feeding one or more sheets of original with the ADF. In S123, the CPU 31 reads information from a RFID tag attached to the first sheet of original, and determines the text direction based on the information. Note that if the CPU 31 fails to read information from the RFID tag, then the CPU 31 determines a default text direction.

In S103, the CPU 31 controls the image reading unit 20 to read an image (one-page worth of image) on a single sheet of original to generate image data, and in S104 adds a page number to the image data.

In S124, the CPU 31 selects an electronic paper display device to which the image data is output, based on the text direction determined in S103 and the position of each electronic paper display device 20A, 20B determined in S122. For example, if the electronic paper display devices 20A and 20B are connected to each other as shown in FIG. 5, and if the text direction is a horizontal direction, then the electronic paper display device 20A on the left side is selected for a first page, and the electronic paper display device 20B on the right side is selected for a following page. On the other hand, if the electronic paper display devices 20A and 20B are connected as shown in FIG. 5, but if the text direction is a vertical direction, then the electronic paper display device 20B is selected for the first page, and the electronic paper display device 20A is selected for the following page.

Next, in S125, the CPU 31 sends the image data generated in S104 to the electronic paper display device selected in S124. In S106, the CPU 31 determines whether or not there is any sheet of original yet to be read. If so (S106:Yes), then the CPU 31 returns to S103 to repeat the process for the next sheet of original. On the other hand, if not (S106:No), then the CPU 31 ends the first reading/sending process.

According to the first reading/sending process described above, only image data corresponding to an electronic paper display device is sent to the electronic paper display device. When each electronic paper display device displays corresponding image data, then a plural-page spread is displayed as shown in FIG. 5, for example. In other words, a plurality of electronic paper display devices displaying corresponding image data together display a single plural-page spread. Because only image data to be displayed on an electronic paper display device is sent to the electronic paper display device, the memory 68 of the electronic paper display device can be saved.

Next, the second reading/sending process will be described with reference to the flowchart of FIG. 11.

Because the processes in S121, S122, and S102 are the same as those of FIG. 10, description thereof will be omitted. In S143, the CPU 31 reads information from a RFID tag attached to the first sheet of original, and determines the orientation (portrait or landscape) based on the information. Note that if the CPU 31 fails to read information from the RFID tag, then the CPU 31 determines a default orientation.

In S103, the CPU 31 controls the image reading unit 20 to read an image (one-page worth of image) on a single sheet of original to generate image data, and in S104 adds a page number to the image data.

In S144, the CPU 31 divides the image data (generates plural sets of divided image data) in accordance with the orientation determined in S143 and the position of each electronic paper display device 20A, 20B deter mined in S122. For example, if the electronic paper display devices 20A and 20B are connected to each other as shown in FIG. 6, and if a display orientation needs to be rotated by 90 degrees, then the CPU 31 rotates a scanned image by 90 degrees and then divides the scanned image into right and left. Then, in S145, the CPU 31 selects one electronic paper display device for each set of the divided image data.

In S146, the CPU 31 sends one of plural sets of the divided image data to each electronic paper display device selected in S145. In S106, the CPU 31 determines whether or not there is any sheet of original yet to be read. If so (S106:Yes), then the CPU 31 returns to S103 to repeat the process for the next sheet of original. On the other hand, if not (S106:No), then the CPU 31 ends the second reading/sending process.

According to the second reading/sending process of the present embodiment, only image data (divided image data) to be displayed on an electronic paper display device is sent to the electronic paper display device. When each electronic paper display device displays the corresponding divided image data, then a single-page worth of image is displayed in an enlarged size, as shown in FIG. 6, for example. In other words, a plurality of electronic paper display devices displaying corresponding divided image data together display a single-page worth of image data. Because the divided image data is sent to the electronic paper display device from the MFP 100, it is unnecessary for the electronic paper display device to divide image data (or extract corresponding part of image data), reducing a burden on the electronic paper display device.

Note that in this second embodiment the text direction and the orientation are determined based on the information stored on the RFID tag. However, the MFP 100 may instead prompt a user to specify the text direction or the orientation before starts reading an original. Alternatively, the MFP 100 may automatically determine the text direction by an optical character reader (OCR) having a function to optically read characters on an original and to recognize the characters by pattern collation.

### Effects

As described above, according to the first and second embodiments of the invention, each electronic paper display device (20A, 20B) recognizes the position thereof when connected to other electronic paper display device, and each electronic paper display device displays image data corresponding to the position. As a result, a complete (single) image is automatically displayed on the plurality of electronic paper display devices connected to each other. Thus, it is unnecessary for a user to correctly arrange the electronic paper display devices to correctly display a single image thereon, because an image displayed on each electronic paper display device is automatically determined based on the position of the electronic paper display device. Thus, a single image can be correctly displayed with a plurality of electronic paper display devices in an easy manner

<Modifications>

While the invention has been described in detail with reference to the embodiments thereof, it would be apparent to those skilled in the art that various changes and modifications may be made therein without departing from the spirit of the invention.

For example, the image processing device is not limited to an MFP, but may be a printing device, a copier device, or the like, as long as the device has an image processing function. Also, the image processing device may instead be an information processing device, such as a personal computer or a workstation.

The electronic paper display device may be provided with a motion sensor or the like, such that the orientation of the electronic paper display device is determined based on a detection signal from the motion sensor. In this case, the display process is executed each time the orientation of the electronic paper display device is changed, so that the electronic paper display device displays image data appropriate for the orientation of the electronic paper display device. For example, when the electronic paper display devices 20A and 20B displaying the two-page spread as shown in FIG. 5 are rotated upside down by 180 degrees while the connection therebetween is maintained, then the image data displayed thereon may be switched between the electronic paper display devices 20A and 20B and the orientation of displayed images may be inverted, in accordance with the rotation.

In the above-described embodiments, a plurality of electronic paper display devices are physically connected. However, the connection is not limited to such physical connection. A complete image can be displayed using a plurality of electronic paper display devices, as long as the relative positiond therebetween can be determined. For example, the position may be determined using such wireless communication system as GPS.

In the above-described embodiments, the electronic paper display device determines a position thereof with the connectors 69A, 69B, 69C, and 69D. However, this is not limitation of the invention. For example, a user may manually input position information for each electronic paper display device to enable the electronic paper display device or the MFP 100 to determine the position based on the inputted position information.

In the above-described embodiments, the MFP 100 wirelessly communicates with the electronic paper display devices 20A and 20B. However, the communication therebetween may be wired communication.

What is claimed is:

1. An image display system comprising:
a plurality of electronic paper display devices, each displaying an image thereon;
a first determining unit that determines positions of the plurality of electronic paper display devices relative to each other; and
a control unit that controls each of the electronic paper display devices in accordance with the positions determined by the determining unit such that the plurality of electronic paper display devices together display a single image.

2. The image display system according to claim 1, wherein the single image is plural-page worth of images and consists of a plurality of page images each displayed on one of the plurality of electronic paper display devices.

3. The image display system according to claim 2, further comprising a second determining unit that determines whether the single image is a vertically written text or a horizontally written text, wherein the control unit allocates one of the plurality of page images to each of the plurality of electronic paper display devices based on a determination made by the second determining unit.

4. The image display system according to claim 1, wherein the single image is a one-page worth of image in an enlarged size, and each of the plurality of electronic paper display devices displays corresponding part of the single image.

5. The image display system according to claim 1, wherein:
each of the electronic paper display devices has a memory unit;
the control unit only stores part of image data into the memory unit of each of the electronic paper display devices, the image data corresponding to the single image, the part of image data corresponding to the position of each of the electronic paper display devices; and
each of the electronic paper display devices only displays part of the single image based on the part of image data stored in the memory unit.

6. The image display system according to claim 1, wherein the control unit controls all of the plurality of electronic paper display devices to together display a different single image when any one of the electronic paper display devices has accepted a page turn command.

7. An image processing device communicable with a plurality of electronic paper display devices, comprising:
a determining unit that determines positions of the plurality of electronic paper display devices relative to each other;
a selecting unit that selects one of the plurality of electronic paper display devices for each of plural sets of image data; and
a sending unit that sends each of the plural sets of image data to one of the plurality of electronic paper display devices selected by the selecting unit, so as to enable the plurality of electronic paper display devices to together display a single image, wherein the single image consists of a plurality of partial image corresponding to the plural sets of image data.

8. An electronic paper display device comprising:
a display unit that displays an image based on data;
a determining unit that determines a position of the electronic paper display device relative to another electronic paper display device located adjacent to the electronic paper display device; and
a control unit that controls the display unit to display the image based on the position of the electronic paper display device, wherein the image is a part of a single image, the single image consisting of the image and another image displayed by the another electronic paper display device.
